(19) United States
(12) Patent Application Publication
(10) Pub. No.: US 2023/0382093 A1
(43) Pub. Date: Nov. 30, 2023

(54) LAMINATOR CAPABLE OF PREVENTING FILM JAMMING

(71) Applicant: SHENZHEN COFFICES ELECTRONICS CO., LTD., Shenzhen, Guangdong (CN)

(72) Inventors: TINGTING LYU, Shenzhen (CN); LUOBIAO LYU, Shenzhen (CN)

(21) Appl. No.: 18/034,074

(22) PCT Filed: Oct. 26, 2021
(86) PCT No.: PCT/CN2021/126356

§ 371 Date: Apr. 27, 2023

(30) Foreign Application Priority Data
Oct. 29, 2020 (CN) 202022440228.6

(51) Int. Cl. B32B 37/00; B65H 7/08

(52) U.S. Cl. CPC B32B 37/0053; B65H 7/08; B65H 2601/11

(57) ABSTRACT

The laminator includes a rack, at least a pair of a first roller and a second roller jointly providing extrusion to a film that passes between the first and second rollers, and at least one film jamming prevention device provided downstream from the first and second rollers along an extrusion direction. Each of the first and second rollers has two ends respectively and rotably mounted on the rack, and both first and second rollers are configured circumferentially with a number of annular slots at intervals. The at least one film jamming prevention device includes a base piece and a number of blades configured at intervals along a side of the base piece, and each blade protrudes from the base piece into an annular slot. The laminator, as described, is capable of preventing film jamming from happening, rather than resolving jamming after it occurs.

### BACKGROUND OF THE INVENTION

### (a) Technical Field of the Invention

The present invention is generally related to laminators, and more particular to a laminator capable of preventing film jamming.

### (b) Description of the Prior Art

Lamination is a process where a polyester film coated with hot-melt adhesive is applied to an object as the object is passed through a laminator under pressure at a high temperature. The laminated object is well protected by the polyester film while being visible through the transparent hot-melt adhesive. The performance of the laminator is the key to the quality of lamination.

China application publication no. CN 109850237A teaches a laminator including a casing, multiple heating tubes, a left wall, a right wall, a transmission roller, and a control board. The two ends of the transmission roller and the heating tubes are respectively connected to the left and right walls. An upper aluminum cover and a lower aluminum covers are joined together and positioned respectively above and below the transmission roller and the heating tubes. Heat insulation foams are configured on the upper and lower aluminum covers. An jamming detector is provided on the right wall electrically connected to the control board. The transmission roller includes a front transmission roller and a rear transmission roller. Correspondingly, front and rear sleeves are configured respectively on each of the left and right walls. The two ends of the front and rear transmission rollers are respectively plugged in the front and rear sleeves.

According to this teaching, as a film is passed to the heating tubes by the transmission rollers, the jamming detector would send a message to the control board if it does not detect the film's passing in a period of time (7 to 10 seconds). The control board then deactivates the front transmission roller and reverses the rear transmission roller so that the film is ejected and not stuck in the transmission roller.

This teaching resolves the film jamming issue after the jamming actually occurs. It cannot prevent the jamming from happening in the first place.

### SUMMARY OF THE INVENTION

A major objective of the present invention is to provide a laminator capable of preventing film jamming from happening, rather than resolving jamming after it occurs.

The laminator includes a rack, at least a pair of a first roller and a second roller jointly providing extrusion to a film that passes between the first and second rollers, and at least one film jamming prevention device provided downstream from the first and second rollers along an extrusion direction. Each of the first and second rollers has two ends respectively and rotably mounted on the rack, and both first and second rollers are configured circumferentially with a number of annular slots at intervals. The at least one film jamming prevention device includes a base piece and a number of blades configured at intervals along a side of the base piece, and each blade protrudes from the base piece into an annular slot.

Furthermore, a front part of each blade that is extended into a corresponding annular slot has a slope.

Furthermore, a front part of each blade that is extended into a corresponding annular slot has a curved slope conforming to the first and second rollers' shapes.

Furthermore, neighboring annular slots have a spacing therebetween less than 5 mm.

Furthermore, spacings between neighboring annular slots increase as the annular slots are positioned farther away from an end towards the other end of the first and second rollers.

Furthermore, spacings between neighboring annular slots increase or decrease as the annular slots are positioned closer to both ends of the first and second rollers.

As described above, a laminator according to the present invention is able to prevent film jamming by the employment of the film jamming prevention device.

Additionally, each film jamming prevention device is integrally formed and, therefore, is convenient to process.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a first roller and a second roller a laminator according to an embodiment of the present invention.

FIG. 2 is a cross-sectional diagram across the A-A line of the laminator of FIG. 1.

FIG. 3 is another schematic cross-sectional diagram across the A-A line of the laminator of FIG. 1.

FIG. 4 is a front-view diagram showing a film jamming prevention device of the laminator of FIG. 1.

FIG. 5 is a perspective diagram showing the film jamming prevention device of FIG. 4.

FIG. 6 is a cross-sectional diagram across the B-B line of the film jamming prevention device of FIG. 4.

FIG. 7 is another cross-sectional diagram across the B-B line of the film jamming prevention device of FIG. 4.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

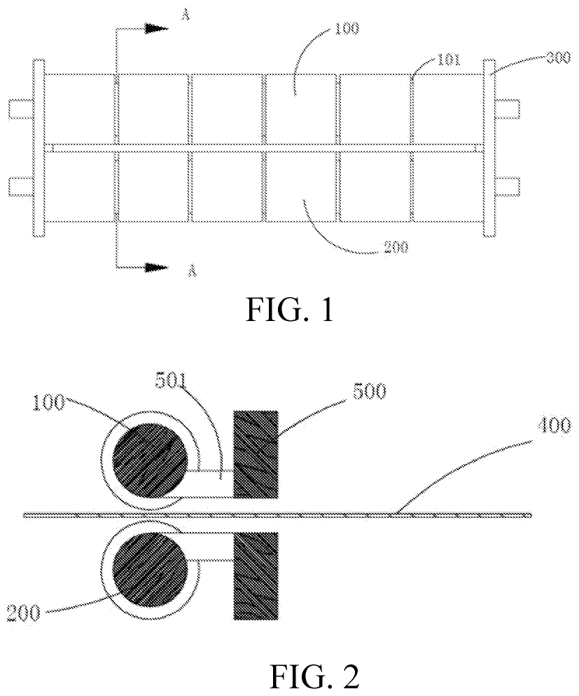

As shown in FIG. 1, a laminator according to an embodiment of the present invention includes at least a pair of two rollers in a rack 300. The pair of two rollers includes a first roller 100 providing simultaneous heating and extrusion and a second roller 200 providing cooling and leveling. Generally, there may be two such pairs of first and second rollers 100 and 200. The first and second rollers 100 and 200 are rotably mounted on the rack 300. Inside the rack 300, there are a control circuit that heats up the first roller 100, and a driving device that engages the first and second rollers 100 and 200 to spin according a configured manner. In the embodiment of the present invention, the first and second rollers 100 and 200 in a same pair jointly provide extrusion.

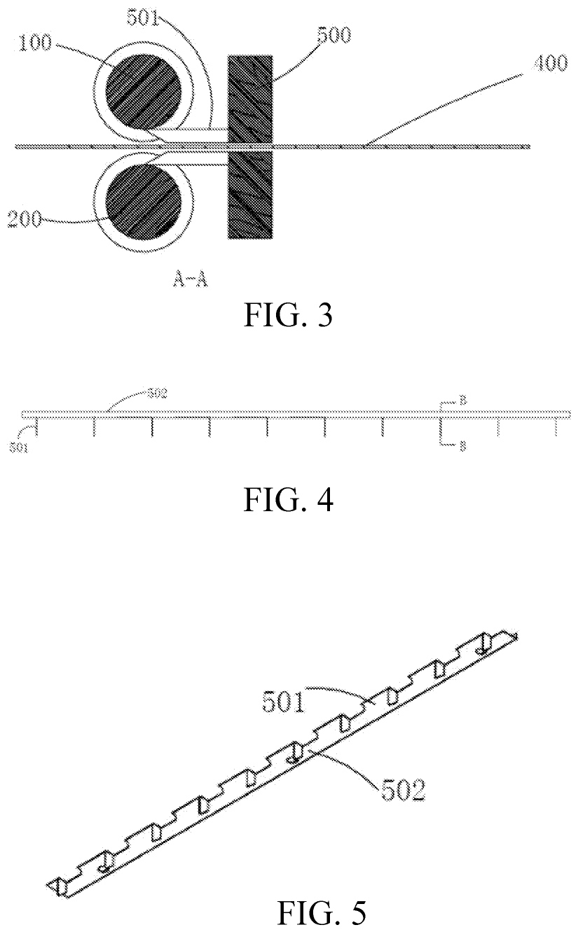

In the present embodiment, both first and second rollers 100 and 200 are configured circumferentially with a number of annular slots 101 at intervals. Each annular slot 101 has a width around 1 mm and a depth that is generally one half or one third of the radius of the roller 100 or 200. At least a film jamming prevention device 500 are provided downstream from the first and second rollers 100 and 200 along an extrusion direction. Each film jamming prevention device 500 includes a number of blades 501 and a base piece 502. The blades 501 are configured at intervals along a side of the base piece 502. Each blade 501 protrudes from the base piece 502 into an annular slot 101 on the first and second rollers 100 and 200. The blades 501 may be made of a metallic material and have a thickness less than 1 mm. The blades 501 do not contact the annular slots 101 as they are extended into the annular slots 101. As such, the first and second rollers 100 and 200 may freely spin with the blades 501 embedded in the annular slots 101 as shown in FIGS. 2 and 3. The base piece 502 is for supporting the blades 501 and may be made of a plastic or other not thermally conductive material. By using a not thermally conductive material may prevent the heat from the first and second rollers 100 and 200 from being quickly dissipated.

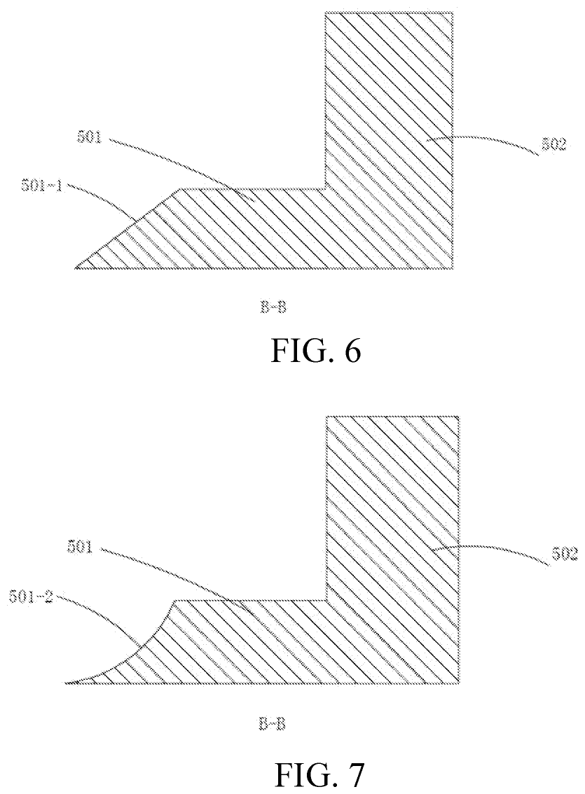

As shown in FIGS. 4, 5, 6, 7, the front part of each blade 501 that is extended into a corresponding annular slot 101 has a slope 501-1. The slope 501-1 may be facing towards or away from the first and second rollers 100 and 200. As shown in FIGS. 2 and 3, the direction of the slopes 501-1 on one film jamming prevention device 500 may be opposite to the direction of the slopes 501-1 on another film jamming prevention device 500. As shown in FIG. 7, in an alternative embodiment, each slope 501-2 may a curved one conforming to the shape of the first and second rollers 100 and 200.

In the present embodiment, each film jamming prevention device 500 is for preventing a film from being adhered to and rolled along with the first and second rollers 100 and 200. As shown in FIGS. 2 and 3, a passage for a film 400 is provided between two film jamming prevention devices 500. The base pieces 502 of the two film jamming prevention devices 500 have their both ends fixed to the rack 300. The blades 501 are extended into the annular slots 101 of the first and second rollers 100 and 200. As the film 400 passes through the heated first and second rollers 100 and 200 to achieve lamination, the film 400 is guided by the blades 501 to move behind the base pieces 502, thereby preventing its being adhered to and rolled along with rollers.

Generally, on each film jamming prevention device 500, the spacing between neighboring blades 501 is determined by the dimension of the film. For laminating an A4-sized paper, the spacing may be 5-10 cm. For laminating a photo, the spacing may be 3-5 cm. For laminating a name card, the spacing may be 2-5 cm. The spacings between the annular slots 101 on the first and second rollers 100 and 200 should be compatible to those between the blades 501 on the base pieces 502.

In alternative embodiments, the spacings between neighboring annular slots 101 on the first and second rollers 100 and 200 can be different. For example, the annular slots 101 adjacent to an end of the rollers have a smaller spacing (e.g., 15 mm) and the spacings increases as the annular slots 101 are positioned closer to the other end (e.g., up to 50 mm) As such, to laminate name cards or similar objects of small widths, they can be inserted adjacent to the other end of the rollers. Alternatively, it is also possible to arrange neighboring annular slots 101 closer if they are positioned in a middle section of the rollers and farther apart as they are positioned closer to the two ends of the rollers, or the other way around. For the former arrangement, to laminate name cards or similar objects of small widths, they can be inserted adjacent to the middle section of the rollers. As to the depths of the annular slots 101, they are related to the lengths of the blades 501.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A laminator, comprising:
a rack;
at least a pair of a first roller and a second roller jointly providing extrusion to a film that passes between the first and second rollers, where each of the first and second rollers has two ends respectively and rotably mounted on the rack, and both first and second rollers are configured circumferentially with a plurality of annular slots at intervals; and
at least one film jamming prevention device provided downstream from the first and second rollers along an extrusion direction, where the at least one film jamming prevention device comprises a base piece and a plurality of blades configured at intervals along a side of the base piece, and each blade protrudes from the base piece into an annular slot.

2. The laminator according to claim 1, wherein a front part of each blade that is extended into a corresponding annular slot has a slope.

3. The laminator according to claim 1, wherein a front part of each blade that is extended into a corresponding annular slot has a curved slope conforming to the first and second rollers' shapes.

4. The laminator according to claim 1, wherein neighboring annular slots have a spacing therebetween less than 5 mm.

5. The laminator according to claim 1, wherein spacings between neighboring annular slots increase as the annular slots are positioned farther away from an end towards the other end of the first and second rollers.

6. The laminator according to claim 1, wherein spacings between neighboring annular slots increase or decrease as the annular slots are positioned closer to both ends of the first and second rollers.

7. The laminator according to claim 2, wherein neighboring annular slots have a spacing therebetween less than 5 mm.

8. The laminator according to claim 3, wherein neighboring annular slots have a spacing therebetween less than 5 mm.

9. The laminator according to claim 2, wherein spacings between neighboring annular slots increase as the annular slots are positioned farther away from an end towards the other end of the first and second rollers.

10. The laminator according to claim 3, wherein spacings between neighboring annular slots increase as the annular slots are positioned farther away from an end towards the other end of the first and second rollers.

11. The laminator according to claim 2, wherein spacings between neighboring annular slots increase or decrease as the annular slots are positioned closer to both ends of the first and second rollers.

12. The laminator according to claim 3, wherein spacings between neighboring annular slots increase or decrease as the annular slots are positioned closer to both ends of the first and second rollers.
